(19) United States
(12) Patent Application Publication
(10) Pub. No.: US 2025/0381497 A1
(43) Pub. Date: Dec. 18, 2025

(54) VIBRATION DEVICE AND UNIT

(71) Applicant: KABUSHIKI KAISHA TOKAI RIKA DENKI SEISAKUSHO, Aichi (JP)

(72) Inventors: Masahiro WASAI, Aichi (JP); Takeshi OHNISHI, Aichi (JP); Keita NAKANE, Aichi (JP); Takashi FUJIHARA, Aichi (JP); Minetaka HORIE, Aichi (JP)

(21) Appl. No.: 18/878,971

(22) PCT Filed: Jun. 22, 2023
(86) PCT No.: PCT/JP2023/023118

§ 371 Date: Dec. 26, 2024

(30) Foreign Application Priority Data
Jul. 6, 2022 (JP) 2022-109168

(51) Int. Cl. A63H 33/30; A63H 5/00; G06F 3/01

(52) U.S. Cl. CPC A63H 33/3072; G06F 3/016; A63H 5/00

(57) ABSTRACT

A vibration device includes a vibration generator arranged in a device body to generate vibration with the device body that allows for attachment of a detachable article. The vibration device further includes a controller that controls the vibration generator based on a selection signal for switching a vibration mode so that vibration is generated with the device body in accordance with a used state of the detachable article and the device body.

### TECHNICAL FIELD

The present disclosure relates to a vibration device and a unit.

### BACKGROUND ART

Patent Literature 1 discloses a traveling toy including a vibration generation means that vibrates the body of the toy. The traveling toy of Patent Literature 1 outputs a sound from a speaker based on detection results of a switch that detects vertical movements of the body and a switch that detects rotations of the wheels. Further, the vibration generation means vibrates the body.

### Citation List

### Patent Literature

Patent Literature 1: Japanese Registered Utility Model No. 3217559

### SUMMARY OF INVENTION

### Technical Problem

In this traveling toy, the vibration generation means may be operated only in a preset vibration pattern. This limits the toy to a single play mode, which lacks versatility.

### Solution to Problem

A vibration device in accordance with one general aspect includes a vibration generator and a controller. The vibration device is arranged in a device body to generate vibration with the device body that allows for attachment of a detachable article. The controller controls the vibration generator based on a selection signal for switching a vibration mode so that vibration is generated with the device body in accordance with a used state of the detachable article and the device body.

A unit in accordance with another general aspect includes a detachable article, and a vibration device that allows for attachment of the detachable article. The unit includes a vibration generator, and a controller. The vibration device is arranged in a device body of the vibration device to generate vibration with the device body. The controller controls the vibration generator based on a selection signal for switching a vibration mode so that vibration is generated with the device body in accordance with a used state of the detachable article and the device body.

### Advantageous Effects of Invention

The present disclosure in accordance with the aspects present various types of vibration in accordance with the used state of the detachable article and the device body.

### BRIEF DESCRIPTION OF DRAWINGS

FIG. 1 is a diagram showing the configuration of a unit and a vibration device in accordance with a first embodiment.

FIG. 2 is a diagram illustrating an example of selective attachment of a detachable article.

FIG. 3 is a schematic diagram of an identifier.

FIG. 4 is a schematic diagram of the identifier.

FIGS. 5A and 5B are diagrams illustrating usage examples of the unit.

FIG. 6 is a diagram showing the configuration of a unit and a vibration device in accordance with a second embodiment.

FIG. 7 is a diagram showing the configuration of a unit and a vibration device in accordance with a third embodiment.

FIGS. 8A and 8B are diagrams illustrating usage examples of a unit in accordance with a fourth embodiment.

FIG. 9 is a diagram showing the configuration of the unit and a vibration device.

FIG. 10 is a schematic diagram of a unit and a vibration device of a modified example.

### DESCRIPTION OF EMBODIMENTS

A first embodiment of the present disclosure will now be described.

### Overview of Unit 1

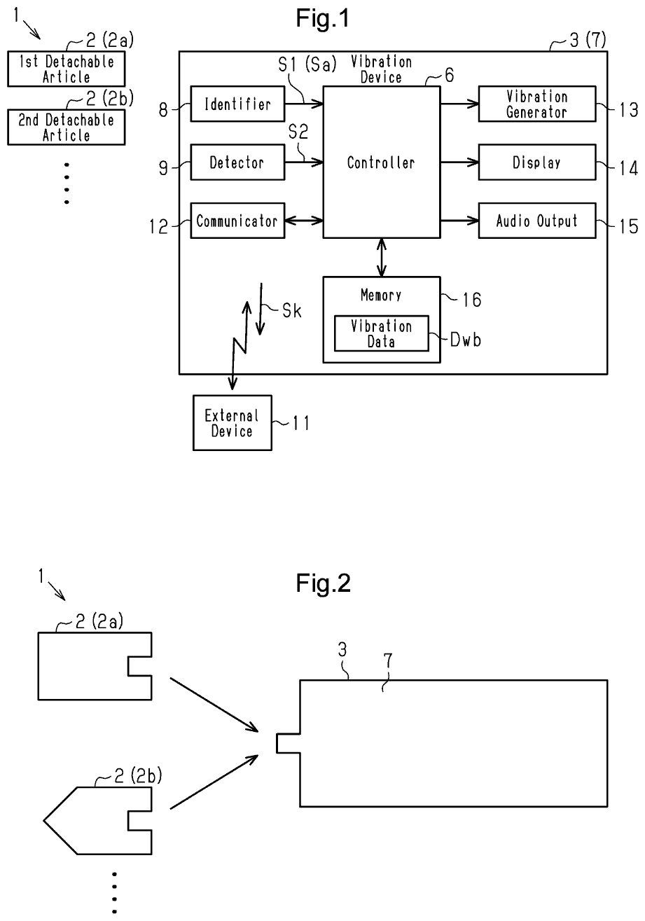

As shown in FIG. 1, a unit 1 includes a detachable article 2 and a vibration device 3 that allows for attachment of the detachable article 2. For example, the detachable article 2 is one of a plurality of detachable articles 2 that are available for the vibration device 3. The detachable article 2 is attachable to and removable from the vibration device 3. FIG. 1 shows a first detachable article 2a and a second detachable article 2b. The vibration device 3 presents vibration to a user of the unit 1 in accordance with the detachable article 2 that is presently attached. The presentation in the present example is, for example, a tactile presentation that provides the user holding the vibration device 3 with a tactile stimulus.

As shown in FIG. 2, the first detachable article 2a and the second detachable article 2b have different shapes. The first detachable article 2a and the second detachable article 2b are selectively secured to the vibration device 3 by a known engagement mechanism (not shown). Examples of the engagement mechanism include a snap-fit or the like.

### Overview of Vibration Device 3

As shown in FIG. 1, the vibration device 3 includes a controller 6 that controls actuation of the vibration device 3. The controller 6 includes, for example, a central processing unit (CPU), a read-only memory (ROM), a random-access memory (RAM), a non-volatile memory, or the like. The controller 6 controls actuation of the vibration device 3, for example, based on programs stored in the ROM.

When the detachable article 2 is one of a plurality of detachable articles 2 that are available for the vibration device 3, the vibration device 3 includes an identifier 8 that identifies the detachable article 2 attached to a device body 7. The identifier 8 identifies which one of the detachable articles 2 is attached to the device body 7. The identifier 8 outputs an identification result S1 to the controller 6. Specifically, the identifier 8 outputs to the controller 6 a selection signal Sa indicating which detachable article 2 is attached to the device body 7. Thus, the selection signal Sa includes the identification result S1 of the identifier 8. The device body 7 is, for example, a casing of the vibration device 3.

The vibration device 3 includes a detector 9 that detects an operation performed by the user on the device body 7. Examples of the detector 9 include a switch, an acceleration sensor, a gyro sensor, a geomagnetic sensor, a pressure-sensitive sensor, or the like. Examples of the switch include a switch for starting vibration, a switch for selecting a vibration type, or the like. The acceleration sensor detects, for example, an acceleration generated with the device body 7. The gyro sensor detects, for example, an inclination of the device body 7. The geomagnetic sensor detects, for example, an orientation of the device body 7. The pressure-sensitive sensor detects, for example, a pressure applied to the device body 7. The detector 9 outputs a detection signal S2 to the controller 6.

The vibration device 3 includes a communicator 12 that performs communication with an external device 11. Examples of the external device 11 include a mobile terminal, a personal computer, a tool, or the like. The communication between the external device 11 and the communicator 12 can be performed through either wireless connection or wired connection. Examples of the wireless communication protocol include Bluetooth®, Wi-Fi®, or the like. For example, when a vibration is generated with the vibration device 3, the vibration device 3 transmits a notification signal Sk indicating the vibration generation from the communicator 12 to the external device 11.

The vibration device 3 includes a vibration generator 13 configured to generate vibration with the device body 7 that allows for attachment of the detachable article 2. Examples of the vibration generator 13 include an electromagnetic actuator, a piezoelectric element, a shape-memory alloy, or the like. Examples of the electromagnetic actuator include a solenoid, a linear resonance actuator, a voice coil motor, or the like.

The vibration device 3 includes, for example, a display 14, an audio output 15, and memory 16. The controller 6 controls operations of the display 14, the audio output 15, and the memory 16. Examples of the display 14 include a display screen, a lamp, or the like. The audio output 15 is, for example, a speaker. The memory 16 stores multiple sets of vibration data Dwb that specify different vibration modes. The vibration data Dwb is, for example, separately prepared for each used state of the unit 1.

The controller 6 controls the vibration generator 13 based on the selection signal Sa for switching the vibration mode so that vibration is generated with the device body 7 in accordance with the used state of the detachable article 2 and the device body 7. The controller 6 of the present example selects the vibration data Dwb from the memory 16 based on the selection signal Sa received from the identifier 8, and then uses the vibration data Dwb to vibrate the vibration generator 13. In this manner, the controller 6 causes the vibration generator 13 to generate the vibration corresponding to the detachable article 2 attached to the device body 7.

The used state of the unit 1 includes, for example, which detachable article 2 is attached to the device body 7. The used state of the unit 1 includes, for example, turning, swinging, tilting, gripping, shaking, striking or the like of the unit 1. The used state of the unit 1 includes, for example, a turning manner, a turning amount, a shaking manner, a shaking speed, a tilting manner, a tilting amount, a gripping manner, a gripping amount, a striking manner, a striking impact, or the like of the unit 1.

The controller 6 vibrates the vibration generator 13, for example, based on the selection signal Sa received from the identifier 8 and the detection signal S2 received from the detector 9. In the present example, the controller 6 determines which vibration data Dwb in the memory 16 to use based on the received selection signal Sa. Further, when the detector 9 detects that a predetermined operation is performed on the vibration device 3, the controller 6 vibrates the vibration generator 13 using the determined vibration data Dwb.

### Overview of Identifier 8

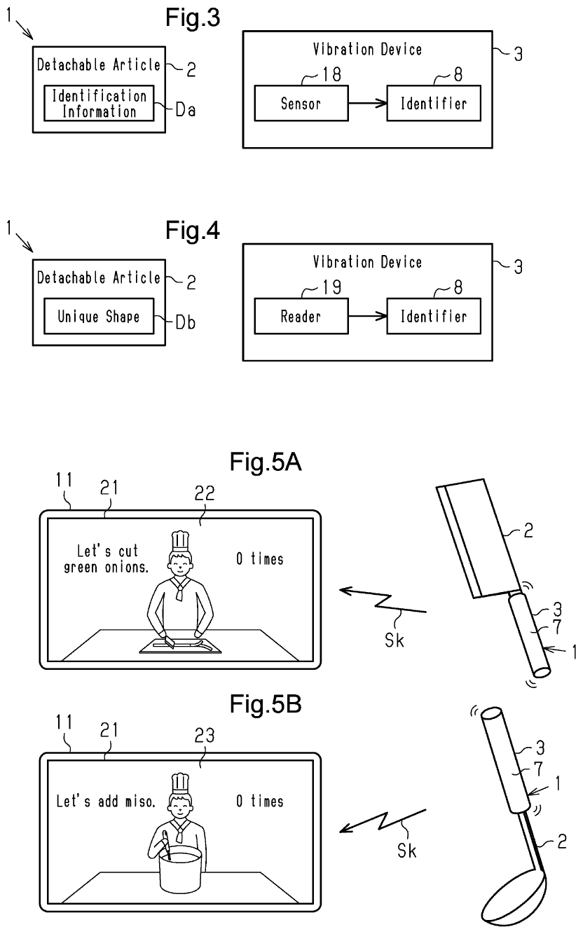

As shown in FIG. 3, the identifier 8 may identify the detachable article 2 by sensing identification information Da of the detachable article 2 with a sensor 18. The sensing method includes, for example, an optical method. In this case, the sensor 18 is, for example, an optical sensor. Examples of the identification information Da include a dot code, a barcode, a QR code®, a color, or the like. Alternatively, the sensing method is not limited to the optical method and may be other types of method, such as a magnetic method.

As shown in FIG. 4, the identifier 8 may identify the detachable article 2 based on a unique shape Db of the detachable article 2. Examples of the unique shape Db include a projection, a recess, a quantity of projections, a corrugation pattern, or the like. The identifier 8 reads the unique shape Db with a reader 19. Examples of the reader 19 include a switch, a visible light camera, an infrared light camera, or the like.

### Operation of the First Embodiment

The operation of the vibration device 3 and the unit 1 in accordance with the present embodiment will now be described. In the present example, the unit 1 is a job experience toy. The job is a cook. In the present example, the unit 1 is used in collaboration with an application (unit collaboration application) registered in the external device 11.

As shown in FIG. 5A, when the unit collaboration application is executed in the external device 11, a screen 22 collaborating with the unit 1 is launched on a display portion 21 of the external device 11. The collaboration screen 22 in FIG. 5A is, for example, a guidance screen for cutting a vegetable with a kitchen knife. In this case, the unit 1 is used as, for example, a kitchen knife. Therefore, the detachable article 2 having the shape of a kitchen knife is attached to the device body 7.

In the present example, the identifier 8 detects which detachable article 2 is attached to the device body 7. In the present example, the detachable article 2 shaped as a kitchen knife has the identification information Da and the unique shape Db indicating that the detachable article 2 is a “kitchen knife”. Accordingly, when the identifier 8 identifies such identification information Da and unique shape Db, the identifier 8 outputs the identification result S1 indicating that the detachable article 2 is a “kitchen knife” to the controller 6 as the selection signal Sa. When the controller 6 receives the selection signal Sa, the controller 6 recognizes that the detachable article 2 presently attached to the device body 7 is a “kitchen knife”. The controller 6 determines that the vibration data Dwb for a “kitchen knife” is to be used among the multiple sets of the vibration data Dwb in the memory 16.

The user performs a movement of cutting a vegetable with the unit 1 in accordance with the guidance of the collaboration screen 22 on the display portion 21 of the external device 11. The movement of cutting a vegetable is, for example, shaking the unit 1 a number of times. This movement is detected by the detector 9 of the device body 7. Each time a shaking amount of the unit 1 becomes equal to a specified value, the controller 6 provides the user with a feel of cutting a vegetable with a kitchen knife through the vibration of the vibration generator 13. That is, the controller 6 presents a tactile sensation of chopping a vegetable with a kitchen knife to the user through repetitive vibrations of the unit 1.

In this case, the controller 6 may output a sound resembling that of cutting a vegetable with a kitchen knife from the audio output 15. In other words, the audio output 15 may output a sound effect in accordance with the vibration of cutting a vegetable with a kitchen knife. Also, the controller 6 may show a display corresponding to the vibration of cutting a vegetable with a kitchen knife on the display 14.

Each time the vibration resembling that of cutting a vegetable with a kitchen knife is generated with the vibration device 3, for example, the vibration device 3 transmits the notification signal Sk indicating the vibration generation from the communicator 12 to the external device 11. When the external device 11 recognizes that the unit 1, used as a “kitchen knife”, has been shaken a specified number of times based on the notification signals Sk, the external device 11 shifts the display portion 21 to the next screen.

Subsequently, as shown in FIG. 5B, the external device 11 shows, for example, a collaboration screen 23 for adding miso into a pot on the display portion 21. In this case, the unit 1 is used as, for example, a ladle. Therefore, the detachable article 2 having the shape of a ladle is attached to the device body 7.

In the present example, the detachable article 2 shaped as a ladle has the identification information Da and the unique shape Db indicating that the detachable article 2 is a “ladle”. Accordingly, the identifier 8 identifies that the detachable article 2 is a “ladle”.

Then, the controller 6 recognizes that the detachable article 2 presently attached to the device body 7 is a “ladle” from the selection signal Sa received as the identification result S1 of the identifier 8. The controller 6 determines that the vibration data Dwb for a “ladle” is to be used among the multiple sets of the vibration data Dwb in the memory 16.

The user performs a movement of stirring the inside of a pot with the unit 1 in accordance with the guidance of the collaboration screen 23 on the display portion 21 of the external device 11. The movement of stirring the pot is, for example, swirling the unit 1 a number of times. This movement is detected by the detector 9 of the device body 7. The controller 6 causes the vibration generator 13 to generate a vibration corresponding to the swirling speed of the unit 1 so as to provide the user with a tactile sensation of swirling a ladle inside a pot. In other words, the controller 6 presents a tactile sensation of swirling a ladle inside a pot to the user through a vibration, allowing the user to feel a load corresponding to the swirling speed of the unit 1.

In this case, the controller 6 may output a sound resembling that of swirling a ladle inside a pot from the audio output 15. In other words, the audio output 15 may output a sound effect in accordance with the vibration resembling that of swirling a ladle inside a pot. Also, the controller 6 may show a display corresponding to the vibration of swirling a ladle inside a pot on the display 14.

Each time the vibration resembling that of swirling a ladle is generated with the vibration device 3, for example, the vibration device 3 transmits the notification signal Sk indicating the vibration generation from the communicator 12 to the external device 11. When the external device 11 recognizes that the unit 1, used as a “ladle”, has been swirled a specified number of times, the external device 11 shifts the display portion 21 to the next screen or ends the application.

Examples of the job serving as an experience subject include a tailor, a car mechanic, a musician, a dairy farmer, a fisher, a miner, a crop farmer, a logger, or the like. Therefore, in accordance with the job description, examples of the detachable article 2 include scissors, a cutter, a sewing machine, a screwdriver, pliers, a spanner, a wrench, a hammer, a saw, a chisel, a plane, a file, a shovel, a claw bar, a chain saw, an electric drill, and a soldering iron, a baton, or the like. The detachable article 2 may be, for example, a self-built paper craft formed by a cardboard or the like.

The detachable article 2 is not limited to a job experience toy and may be, for example, an educational toy. Examples of the educational toy include toy blocks. In this case, vibration is presented to a user in accordance with combinations of the shapes or colors of the blocks.

The vibration device 3 is not limited to an item held by a user and may be, for example, a base (display stage) of an exhibit. In this case, examples of the detachable article 2 include a miniature model, a figure, or the like. Examples of the miniature model include a miniature model of a car, a train, a motorcycle, an airplane, a ship, or the like. Examples of the figure include a figure of a dinosaur or an animal, a doll, a stuffed toy, or the like. Further, the detachable article 2 may be, for example, an item attachable to a figure. Examples of the item include clothes, shoes, a pendant, a backpack, or the like.

The unit 1 may be, for example, a member such as a remote controller for remotely operating an apparatus. In this case, examples of the detachable article 2 include a driving simulator, an experience simulation instrument, an amusement arcade device, a training device, a radio-controlled model (RADICON®) controller, a drone controller, a smartphone case, a smartphone extension controller, or the like.

### Advantages of the First Embodiment

The vibration device 3 (unit 1) of the above embodiment has the following advantages.
(1-1) The vibration device 3 includes the controller 6 and the vibration generator 13. The vibration generator 13 is arranged in the device body 7 to generate vibration with the device body 7 that allows for attachment of the detachable article 2. The controller 6 controls the vibration generator 13 based on the selection signal Sa for switching the vibration mode so that vibration is generated with the device body 7 in accordance with the used state of the detachable article 2 and the device body 7.

With this configuration, the detachable article 2 is attachable to the device body 7 of the vibration device 3. Further, the vibration generated with the device body 7 is switched in accordance with the used state of the detachable article 2 and the device body 7. This presents the vibration corresponding to the used state of the detachable article 2 and the device body 7 to the user of the vibration device 3. Consequently, various types of vibration may be presented in accordance with the used state of the detachable article 2 and the device body 7.
(1-2) The detachable article 2 is one of a plurality of detachable articles 2 that are available for the vibration device 3. The vibration device 3 includes the identifier 8 that identifies the detachable article 2 selectively attached to the device body 7. The selection signal Sa includes the identification result S1 of the identifier 8. The controller 6 controls the vibration generator 13 based on the identification result S1. With this configuration, the identifier 8 identifies the detachable article 2 attached to the device body 7. This correctly identifies which detachable article 2 is attached to the device body 7.
(1-3) The identifier 8 identifies the detachable article 2 by reading the identification information Da of the detachable article 2 with the sensor 18 of the device body 7. With this configuration, the detachable article 2 is identified based on the dedicated identification information Da assigned to each detachable article 2. This further contributes to obtaining a correct identification result S1.
(1-4) The identifier 8 identifies the detachable article 2 by reading the unique shape Db of the detachable article 2 with the reader 19 of the device body 7. With this configuration, the detachable article 2 is identified based on the shape of the detachable article 2. Accordingly, the detachable article 2 does not have to include a member for identifying the detachable article 2.
(1-5) The vibration device 3 includes the detector 9 that detects an operation performed by the user on the device body 7. The controller 6 switches vibration between on and off based on the detection signal S2. With this configuration, vibration is generated with the device body 7 at an optimal time when the detector 9 detects a predetermined movement of the device body 7.

### Second Embodiment

A second embodiment will now be described. The second embodiment differs from the first embodiment in the method for identifying the detachable article 2. Therefore, same reference numerals are given to those components that are the same as the corresponding components of the first embodiment. The description will focus on the differences from the first embodiment.

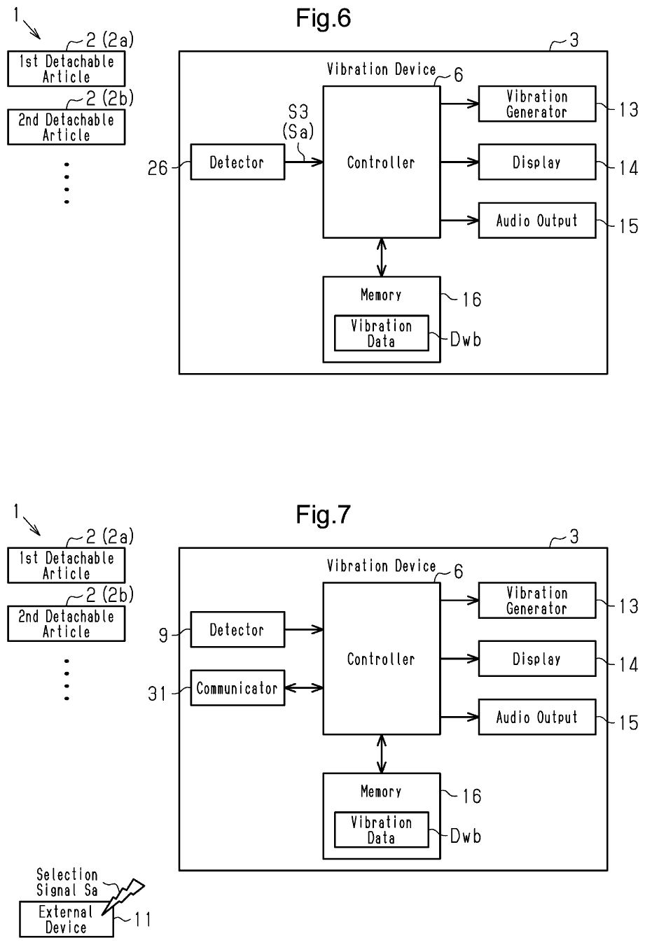

As shown in FIG. 6, the vibration device 3 includes a detector 26 that detects the detachable article 2 attached to the device body 7. Preferably, the detector 26 is the same as the detector 9 of the first embodiment. That is, it is preferred that the detector 26 includes various types of switches or sensors described above. The detector 26 detects, for example, which detachable article 2 is attached to the device body 7.

When the detector 26 is a switch, the switch is switch-operated to a state corresponding to the detachable article 2 attached to the vibration device 3. Therefore, a switch signal, which serves as a detection signal S3 of the detector 26, is output to the controller 6 as the selection signal Sa indicating which the detachable article 2 is attached to the vibration device 3.

When the detector 26 is a sensor, for example, each detachable article 2 will assume a unique orientation when attached to the vibration device 3 or undergo a unique motion during use. Accordingly, the sensor obtains a sensing result corresponding to the detachable article 2 attached to the vibration device 3. Therefore, a sensor signal, which serves as a detection signal S3 of the detector 26, is output to the controller 6 as the selection signal Sa indicating which the detachable article 2 is attached to the vibration device 3.

The controller 6 controls the vibration generator 13 based on the detection signal S3 received from the detector 26 as the selection signal Sa. The controller 6 selects the vibration data Dwb from the memory 16 based on the detection signal S3 received from the detector 26, and then uses the vibration data Dwb to vibrate the vibration generator 13. In this manner, the controller 6 causes the vibration generator 13 to generate the vibration corresponding to the detachable article 2 attached to the device body 7.

### Advantages of the Second Embodiment

The vibration device 3 (unit 1) of the above embodiment has the following advantages.
(2-1) The vibration device 3 includes the detector 26 that detects the detachable article 2 attached to the device body 7. The selection signal Sa includes the detection signal S3 detected by the detector 26. The controller 6 controls the vibration generator 13 based on the detection signal S3. With this configuration, the detachable article 2 is identified based on the detection signal S3 of the detector 26. Accordingly, the detachable article 2 does not have to include a member for identifying the detachable article 2.

### Third Embodiment

A third embodiment will now be described. The third embodiment will also be described in detail focusing on the differences from the above embodiments.

As shown in FIG. 7, the vibration device 3 includes a communicator 31 configured to communicate with the external device 11 through at least one of wireless connection or wired connection. When the communication between the external device 11 and the communicator 31 is performed through wireless connection, examples of the communication protocol include Bluetooth®, Wi-Fi®, or the like.

The type of vibration is selected by operating the external device 11. Specifically, the vibration types are shown on the display portion 21 of the external device 11, and the vibration to be generated with the detachable article 2 is specified. For example, in a case in which the detachable article 2 is a figure model of a car, the vibration type may be indirectly selected by selecting the vehicle model. When the vibration type is selected, the external device 11 transmits to the device body 7 a selection signal Sa that notifies the vibration device 3 of the selected vibration.

The vibration device 3 receives the selection signal Sa transmitted from the external device 11 using the communicator 31. The controller 6 controls the vibration generator 13 based on the selection signal Sa received by the communicator 31. Specifically, the controller 6 causes the vibration generator 13 to generate the vibration selected with the external device 11 so as to present the vibration corresponding to the detachable article 2 attached to the vibration device 3 to the user.

### Advantage of the Third Embodiment

The vibration device 3 (unit 1) of the above embodiment has the following advantages.
(3-1) The vibration device 3 includes the communicator 31 configured to communicate with the external device 11 through at least one of wireless connection or wired connection. The selection signal Sa is transmitted from the external device 11 to the device body 7. The controller 6 controls the vibration generator 13 based on the selection signal Sa received by the communicator 31. This configuration specifies the vibration to be generated with the device body 7 based on the selection signal Sa transmitted from the external device 11 to the device body 7. Therefore, the vibration corresponding to the detachable article 2 may be generated with the device body 7 without identifying which detachable article 2 is attached to the device body 7.

### Fourth Embodiment

A fourth embodiment will now be described. The fourth embodiment will also be described in detail focusing on the differences from the above embodiments.

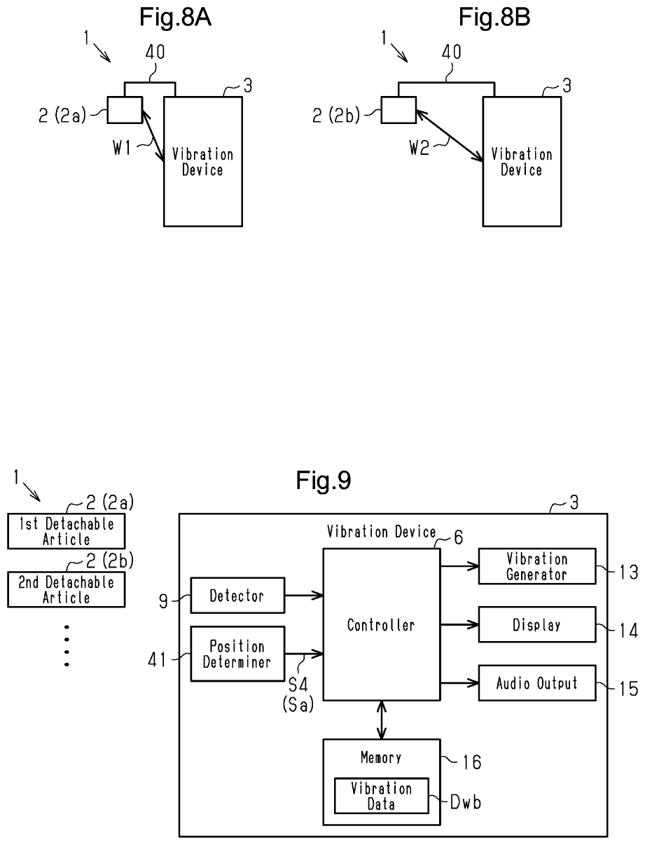

As shown in FIGS. 8A and 8B, the detachable articles 2 are attached to the device body 7, for example, by brackets 40 having different lengths. In this case, when the detachable articles 2 are attached to the vibration device 3 in the unit 1, the distance between the detachable article 2 and the vibration device 3 differs between the detachable articles 2. In the present example, for example, the distance with the first detachable article 2a is denoted by “W1”, and the distance with the second detachable article 2b is denoted by “W2”.

As shown in FIG. 9, the vibration device 3 includes a position determiner 41 that determines the positional relationship between the detachable article 2 and the device body 7. The position determiner 41 uses, for example, an infrared light camera to determine the positional relationship between the detachable article 2 and the device body 7. In this manner, the position determiner 41 determines the distance between the detachable article 2 and the device body 7, for example, using an image of the infrared light camera.

As shown in FIG. 8A, when the first detachable article 2a is attached to the device body 7, the position determiner 41 transmits a determination result S4 indicating that the distance between the members is “W1” to the controller 6 as the selection signal Sa. Further, as shown in FIG. 8B, when the second detachable article 2b is attached to the device body 7, the position determiner 41 transmits a determination result S4 indicating that the distance between the members is “W2” to the controller 6 as the selection signal Sa.

The controller 6 controls the vibration generator 13 based on the selection signal Sa received from the position determiner 41. Specifically, the controller 6 causes the vibration generator 13 to generate a vibration corresponding to the distance between the detachable article 2 and the vibration device 3 so as to present different types of vibration to the user in accordance with the detachable article 2 attached to the vibration device 3.

### Advantages of Fourth Embodiment

The vibration device 3 (unit 1) of the above embodiment has the following advantages.
(4-1) The vibration device 3 includes the position determiner 41 that determines the positional relationship between the detachable article 2 and the device body 7. The selection signal Sa includes the determination result S4 of the position determiner 41. The controller 6 controls the vibration generator 13 based on the determination result S4. This configuration generates an optimal vibration with the device body 7 in accordance with the positional relationship between the detachable article 2 and the device body 7.

### Other Embodiments

The above embodiments may be modified as follows. The above embodiments and the following modifications can be combined as long as they remain technically consistent with each other.

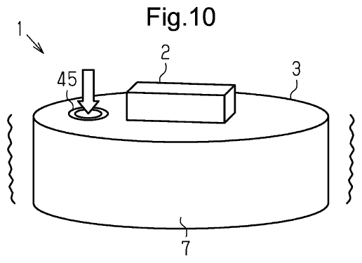

In each embodiment, as shown in FIG. 10, the vibration device 3 may vibrate a switch 45 arranged in the device body 7 together with the device body 7. The switch 45 is, for example, for starting vibration. The switch 45 is, for example, a push switch. When the switch 45 is operated, the controller 6 vibrates the switch 45 together with the device body 7.

This configuration presents the vibration to the user from the switch 45 at a time when the switch 45 is operated. Accordingly, the user directly receives an optimal vibration at an optimal time. The switch 45 is not limited to a push switch and may be, for example, a tact switch, a toggle switch, a slide switch, a dual in-line package (DIP) switch, a rotary switch, a rocker switch, or the like.

In each embodiment, the detachable article 2 may be used with, for example, a vehicle on-board component or part of the vehicle on-board component. Examples of the vehicle on-board component include an engine start switch, a heater control switch, an electric parking brake (EPB) switch, a steering wheel switch, a console switch, a light switch, an instrument panel switch (e.g., a trip switch), a head-up module, a lever combination switch, a paddle switch, a window regulator switch, a hazard switch, a dial switch, an audio switch, a tilt & telescopic steering (TELESCO®), a touchpad, a seat switch, a mirror switch, a hazard switch, a fog lamp switch, a defogger switch, a Rheostat, a neutral start switch, a parking brake switch, an engine oil pressure switch, a door lock switch, a brake lamp switch, a courtesy lamp switch, a back lamp switch, a back door switch, a shift lever, a key, a seat belt, a seat, a mirror, a buckle, a steering wheel, a display, a sun visor, a floor, a door handle, a brake, an accelerator, a side brake, a window glass, an armrest, a palmrest, a headrest, a dashboard, or the like.

In each embodiment, the detachable article 2 may be, for example, a mouse or a keyboard of a personal computer. Alternatively, the detachable article 2 may be, for example, a tablet, an earphone, or a headphone.

In each embodiment, the detachable article 2 may be used with, for example, a piece of furniture, a house, a home appliance, or part thereof. In this case, examples of the detachable article 2 include a wall, a floor, a window, a desk, a chair, a sofa, an armrest, a cushion, a bath, a bed, a pillow, a door, a door knob, a telephone, or the like.

In each embodiment, the detachable article 2 may be used with, for example, a piece of stationery or part thereof. Examples of the stationery include a pen, a notebook, a whiteboard, a blackboard, or the like.

In each embodiment, the detachable article 2 may be, for example, a braille block arranged on a road.

In each embodiment, when the detachable article 2 is a remote controller, the remote controller may be for, for example, a robot arm used in a medical setting or a factory (automobile factory), a construction vehicle, a piece of heavy machinery, or the like.

In each embodiment, the detachable article 2 may be, for example, a product sample, a medical rehabilitation device, or a musical instrument.

In each embodiment, there may be only one detachable article 2.

In each embodiment, the controller 6 and the identifier 8 may each be formed by (1) one or more processors that run a computer program (software) or (2) a combination of such processors and one or more dedicated hardware circuits, such as an application specific integrated circuit (ASIC) that executes at least part of various types of processes. The processor includes a CPU and a memory, such as a RAM or a ROM. The memory stores program codes or commands configured to cause the CPU execute processes. The memory (computer readable medium) may be any available medium accessible by a versatile or dedicated computer. Alternatively, instead of a computer including the above-described processor, there may be processing circuitry formed by one or more dedicated hardware circuits that execute all of various types of processes.

In each embodiment, the controller 6 and the identifier 8 may be formed by separate processors. Alternatively, the functionalities of the controller 6 and the identifier 8 may be partially shared by a common processor. In this manner, the controller 6 and the identifier 8 are not limited to independent functional blocks and may be shared by the same functional block or partially shared by functional blocks.

The present disclosure is illustrated through each embodiment. However, the present disclosure is not limited to the structures or configurations of the embodiments. The present disclosure includes various modified examples and modifications within the scope of equivalence. Additionally, various combinations and modes and one, more, or less of these elements in other combinations and forms are included in the range and conceptual scope of the present disclosure.

1. A vibration device, comprising:
a vibration generator arranged in a device body to generate vibration with the device body that allows for attachment of a detachable article; and
a controller that controls the vibration generator based on a selection signal for switching a vibration mode so that vibration is generated with the device body in accordance with a used state of the detachable article and the device body.

2. The vibration device according to claim 1, wherein the detachable article is one of a plurality of detachable articles that are available for the device body, the vibration device further comprising:
an identifier that identifies the detachable article selectively attached to the device body, wherein
the selection signal includes an identification result of the identifier, and
the controller controls the vibration generator based on the identification result.

3. The vibration device according to claim 2, wherein the identifier identifies the detachable article by reading identification information of the detachable article with a sensor of the device body.

4. The vibration device according to claim 2, wherein the identifier identifies the detachable article by reading a unique shape of the detachable article with a reader of the device body.

5. The vibration device according to claim 1, further comprising:
a detector that detects an operation performed by a user on the device body,
wherein the controller switches the vibration between on and off based on a detection signal of the detector.

6. The vibration device according to claim 1, further comprising:
a detector that detects the detachable article attached to the device body, wherein
the selection signal includes a detection signal detected by the detector, and
the controller controls the vibration generator based on the detection signal.

7. The vibration device according to claim 1, further comprising:
a communicator configured to communicate with an external device through at least one of wireless connection or wired connection, wherein
the selection signal is transmitted from the external device to the device body, and
the controller controls the vibration generator based on the selection signal received by the communicator.

8. The vibration device according to claim 1, further comprising:
a position determiner that determines a positional relationship between the detachable article and the device body, wherein
the selection signal includes a determination result of the position determiner, and
the controller controls the vibration generator based on the determination result.

9. The vibration device according to claim 1, further comprising:
a switch for starting vibration,
wherein, when the switch is operated, the controller vibrates the switch together with the device body.

10. A unit including a detachable article, and a vibration device that allows for attachment of the detachable article, the unit comprising:
a vibration generator arranged in a device body of the vibration device to generate vibration with the device body; and
a controller that controls the vibration generator based on a selection signal for switching a vibration mode so that vibration is generated with the device body in accordance with a used state of the detachable article and the device body.
